(19) United States
(12) Patent Application Publication
(10) Pub. No.: US 2016/0214380 A1
(43) Pub. Date: Jul. 28, 2016

(54) PRINTING DEVICE AND PRINTING METHOD

(71) Applicant: MIMAKI ENGINEERING CO., LTD., NAGANO (JP)

(72) Inventor: MASARU OHNISHI, NAGANO (JP)

(73) Assignee: MIMAKI ENGINEERING CO., LTD., NAGANO (JP)

(21) Appl. No.: 14/997,577

(22) Filed: Jan. 18, 2016

(30) Foreign Application Priority Data
Jan. 22, 2015 (JP) 2015-010489

(51) Int. Cl. B41J 2/145

(52) U.S. Cl. CPC B41J 2/145

(57) ABSTRACT

A printing device is provided with a head section including nozzle rows; a main scan driving section, and a sub scan driving section. The multiple nozzle rows that respectively discharges ink droplets of ink of a same color, and each of the multiple nozzle rows is aligned along a main scanning direction so that at least a part of their positions is overlapped in a sub scanning direction. In each of the nozzle rows, multiple nozzles is aligned with a constant interval in the sub scanning direction. In a case where a resolution corresponding to the interval of the nozzles in the sub scanning direction in each of the nozzle rows is denoted as a nozzle resolution D1, and a resolution in the sub scanning direction upon performing printing at a maximum resolution in the printing device is denoted as a maximum resolution D2, and D2 is higher than D1.

### CROSS REFERENCE TO RELATED APPLICATIONS

This application claims the priority benefit of Japanese Patent Application No. 2015-010489, filed on Jan. 22, 2015. The entirety of the above-mentioned patent application is hereby incorporated by reference herein and made a part of this specification.

### TECHNICAL FIELD

The present disclosure relates to a printing device and a printing method.

### DESCRIPTION OF THE BACKGROUND ART

Conventionally, an inkjet printer that performs printing by an inkjet scheme has been widely used. Further, as a method for performing printing by an inkjet printer, a method that performs printing by a multi-pass scheme has been known (for example, see Patent Document 1).

[Patent Document 1] JP 2014-144537 A

### SUMMARY

A multi-pass scheme is a scheme that, for example, performs plural times of main scanning operations (scan operations) on respective positions in a printed region in a medium (media) to be a print target. By printing using the multi-pass scheme, an influence of variation in discharge properties of respective nozzles in inkjet heads and the like can be suppressed. Further, for example, it becomes possible to perform printing at a higher resolution than a resolution corresponding to a nozzle pitch in nozzle rows of the inkjet heads.

With respect to this, in a configuration of a conventional inkjet printer, if printing is performed by the multi-pass scheme, printing speed slows down due to an increase in a number of required main scanning operations. Further, for example, in order to perform printing at higher quality, a number of print passes needs to be increased in some cases. Further, as the result, the printing speed further slows down.

More specifically, in inkjet heads having been widely used in the recent years, a resolution corresponding to the nozzle pitch is for example about 150 dpi. Further, in this case, if a high quality printing at a resolution of 600 dpi or more is to be performed, the number of the printing passes needs to be set for example to 16 passes or more.

However, in the inkjet printer, the printing speed is an extremely important function. Due to this, even in the case of performing high quality printing, realization of faster printing speed is desired. Thus, the present disclosure aims to provide a printing device and a printing method that can solve the above problems.

The inventors of the present application have, as a result of eager study, considered speeding up printing speed by reducing the number of the necessary print passes by using a plurality of nozzle rows (or inkjet heads) for one color. Further, as a more specific configuration therefor, initially, a consideration was given to a use of a nozzle row in which nozzles were arranged at a high resolution that was same as a print resolution (for example, 600 dpi). By using such a configuration, for example, high quality printing at high resolution can be enabled without performing the multi-pass scheme printing.

However, in the case of using such a configuration, a quality required for inkjet head that forms such a nozzle row will become extremely high, which brings forth a risk of a great increase in a price of the inkjet head. Further, for example, in a case of a piezoelectric inkjet head that uses a piezoelectric element as its driving element, it is difficult in its nature to arrange nozzles at such high resolution of 600 dpi or more.

Thus, the inventors of the present application have, as a result of further study, eagerly considered of performing printing using a plurality of nozzle rows having nozzles arranged at a lower resolution than the print resolution. Even in configuring as above, by using a plurality of nozzle rows for one color of ink, as compared for example to the conventional configuration, the number of the necessary main scanning operations can be reduced. Further, due to this, for example, the printing speed can be sped up. Further, in this case, for example, an inkjet head that is identical to or similar to a known inkjet head can be used. Due to this, by configuring as above, for example, high quality printing at a high resolution can be performed at high speed while suppressing cost. That is, to solve the above problems, the present disclosure includes the following configurations.

(Configuration 1)

A printing device that performs printing on a medium using an inkjet scheme, the printing device including: a head section including nozzle rows in which nozzles for discharging ink droplets are aligned; a main scan driving section that causes the head section to perform a main scanning operation of discharging ink droplets while moving in a preset main scanning direction; and a sub scan driving section that moves the head section in a sub scanning direction that is perpendicular to the main scanning direction relative to the medium, wherein the head section includes a plurality of the nozzle rows that respectively discharges ink droplets of ink of a same color, each of the plurality of nozzle rows is aligned along the main scanning direction so that at least a part of their positions is overlapped in the sub scanning direction, in each of the nozzle rows, a plurality of the nozzles is aligned with a constant interval in the sub scanning direction, and in a case where a resolution corresponding to the interval of the nozzles in the sub scanning direction in each of the nozzle rows is denoted as a nozzle resolution D1, and a resolution in the sub scanning direction upon performing printing at a maximum resolution in the printing device is denoted as a maximum resolution D2, the maximum resolution D2 is a resolution higher than the nozzle resolution D1.

In configuring as above, for example, in a case of performing printing at the maximum resolution D2 that is higher than the nozzle resolution D1, by using the plurality of nozzle rows for one color of ink, the number of necessary main scanning operations can suitably be reduced. Further, due to this, for example, in a case of performing high-resolution printing, printing speed can suitably be sped up. Further, in this case, for example, by using the plurality of nozzle rows for one color of ink or the like, an influence of a variation in discharge properties of respective nozzles can be suppressed as well. Thus, by configuring as above, for example, the high quality printing at high resolution can suitably be performed.

Further, in this case, since the nozzle resolution D1 is lower than the maximum resolution D2, for example, cost or the like of the inkjet heads can suitably be suppressed. Further, for example, use of inkjet heads of a piezoelectric scheme or the like also becomes possible. Thus, by configuring as above, for example, the high quality printing at high resolution can be performed at high speed, while suppressing the cost.

Notably, as the ink used in the head section, for example, ultraviolet curing ink (UV ink) or the like may be used. In this case, the printing device is preferably further provided with an ultraviolet light source, for example. Further, as the ink, ink other than the ultraviolet curing ink may be used. For example, as the ink, solvent UV ink, solvent ink, latex ink, or water-soluble dye ink, or the like may be used. In these cases, the printing device preferably further includes a heater or the like for heating the medium, for example.

(Configuration 2)

The main scan driving section and the sub scan driving section may cause the head section to perform printing by a multi-pass scheme that performs plural times of the main scanning operations for each position in a printed region where printing is to be performed on the medium, and the maximum resolution D2 may be a maximum resolution obtained upon performing the printing in the multi-pass scheme.

By configuring as above, for example, the high quality printing at high resolution can suitably be performed. Further, for example, by using the plurality of nozzle rows for one color of ink, a number of necessary print passes can suitably be reduced. Further, due to this, for example, the printing speed can suitably be sped up.

(Configuration 3)

The maximum resolution D2 may be a resolution that is N times the nozzle resolution D1 (N being an integer of 2 or more). In a case of performing printing by the maximum resolution D2, the printing device perform is the printing by the multi-pass scheme that sets the pass number of the printing to N or more, for example. By configuring as above, for example, the high quality printing at high resolution can suitably be performed.

(Configuration 4)

In the head section, piezoelectric elements may be used as driving elements for causing the ink droplets to be discharged. By configuring as above, for example, the high quality printing at high resolution can suitably be performed by using the ink jet heads of the piezoelectric scheme.

(Configuration 5)

The printing device may perform printing using plural types of ink with colors different from each other, and the head section may include the plurality of nozzle rows for each of the colors. Each of the plurality of types of ink is a color of process colors of printing. The colors of the process colors of printing refers to colors such as Y (yellow), M (magenta), C (cyan), and K (black), for example. By configuring as this, for example, the high quality printing at high resolution can suitably be performed by using the plurality of types of ink. Further, due to this, for example, a high quality color image can suitably be printed.

(Configuration 6)

The plurality of nozzle rows that discharges the ink droplets of the same color of ink may be arranged along the main scanning direction with the respective nozzles having matched positions in the sub scanning direction. By configuring as above, for example, the plurality of nozzle rows can suitably be used for each color.

(Configuration 7)

Within the plural types of ink, the nozzle rows that discharge the ink droplets of one color and the nozzle rows that discharge the ink droplets of another color may be arranged with the positions of the respective nozzles displaced in the sub scanning direction.

In configuring as above, in each main scanning operation, the dots of the respective colors of ink are formed by having their positions in the sub scanning direction displaced from each other. Thus, by configuring as above, for example, dots of the ink of different colors can suitably be prevented from being formed adjacent to each other in the main scanning direction. Further, due to this, an occurrence of color smearing or the like is suitably prevented among the dots of the ink of different colors.

(Configuration 8)

The plurality of nozzle rows that discharges the ink droplets of the same color of ink may be arranged along the main scanning direction with the respective nozzles having positions in the sub scanning direction displaced from one another.

In a case of performing printing by the main scanning operation, dot coupling is more likely to occur if dots of ink are consecutively formed at positions that are adjacent in the main scanning direction. Further, as a result, line bands and the like may be generated.

With respect to this, in configuring as above, in each of the main scanning operations, each of the plurality of nozzle rows for each color has its position in the sub scanning direction displaced from each other for example, and thereby forms the ink dots. Then, in this case, the printing by the plurality of nozzle rows can be performed without forming the ink dots consecutively at positions that are adjacent in the main scanning direction for the dots of ink of the same color. Thus, by configuring as above, for example, the dots of ink of the same color can suitably be prevented from coupling in the main scanning direction. Further, due to this, for example, the generation of line bands or the like is suppressed, and printing of an even higher quality can suitably be performed.

(Configuration 9)

A size of a positional displacement for the positions in the sub scanning direction of the nozzles at ends of the plurality of nozzle rows arranged adjacent to one another in the main scanning direction may be set to be larger than a distance corresponding to a spatial frequency by which human vision sensitivity is maximized.

In a case of observing an image printed by the main scanning operations, there is a case where alignment of the ink dots formed by nozzles at ends among the nozzle rows is more noticeable. Further, as a result, there is a case where the line band or the like stands out, and is visually recognized. Further, especially, in the case of using the plurality of nozzle rows for the same color, if the positions of the nozzles at the ends in each nozzle row are close to each other, an influence of the nozzles at the ends overlap, and there is a risk that the line band stands out more prominently.

With respect to this, by configuring as above, for example, for the plurality of nozzle rows, an influence that is imposed on human vision by the ink dots formed by the nozzles at the ends of the nozzle rows can be dispersed by sufficiently displacing the end positions of the nozzle rows in the sub scanning direction. Further, due to this, for example, the line band standing out prominently or the like can suitably be suppressed, and the high quality printing can suitably be performed.

(Configuration 10)

A size of a positional displacement for the positions in the sub scanning direction of the nozzles at ends of the plurality of nozzle rows arranged adjacent to one another in the main scanning direction may be 200 μm or more.

By configuring as above, for example, for the plurality of nozzle rows, the influence that is imposed on human vision by the ink dots foamed by the nozzles at the ends of the nozzle rows can be dispersed by sufficiently displacing at the end positions of the nozzle rows in the sub scanning direction. Further, due to this, for example, the line band standing out prominently or the like can suitably be suppressed, and the high quality printing can suitably be performed.

(Configuration 11)

A printing method that performs printing on a medium using an inkjet scheme, the printing method including: causing a head section that includes nozzle rows in which nozzles for discharging ink droplets are aligned to perform: a main scanning operation of discharging ink droplets while moving in a preset main scanning direction; and a sub scanning operation of moving in a sub scanning direction that is perpendicular to the main scanning direction relative to the medium, wherein the head section includes a plurality of the nozzle rows that respectively discharges ink droplets of a same color, each of the plurality of nozzle rows is aligned along the main scanning direction so that at least a part of their positions is overlapped in the sub scanning direction, in each of the nozzle rows, a plurality of the nozzles is aligned with a constant interval in the sub scanning direction, and in a case where a resolution corresponding to the interval of the nozzles in the sub scanning direction in each of the nozzle rows is denoted as a nozzle resolution D1, and a resolution in the sub scanning direction upon performing printing at a maximum resolution in the printing device is denoted as a maximum resolution D2, the printing is performed with the maximum resolution D2 that is a resolution higher than the nozzle resolution D1. By configuring as this, for example, advantages similar to those of Configuration 1 can be obtained.

According to the present disclosure, for example, a high quality printing can more suitably be performed.

### BRIEF DESCRIPTION OF THE DRAWINGS

FIGS. 1A and 1B show an example of a printing device 10 according to an embodiment of the present disclosure. Specifically, FIGS. 1A and 1B are a front diagram and an upper diagram showing an example of a configuration of a primary part of the printing device 10.

FIG. 2 is a diagram showing an example of a referential configuration example 32, which is an example of a head section according to a referential example.

FIGS. 3A and 3B show examples of a printing operation using the referential configuration example 32. Specifically, FIG. 3A is a diagram describing an arrangement of nozzles 304 in inkjet heads 204. FIG. 3B is a diagram explaining an operation to perform printing on a medium 50 using the referential configuration example 32.

FIG. 4 is a diagram showing an example of a configuration of a head section 12 in a present example.

FIG. 5 is a diagram showing a modified example of the configuration of the head section 12.

FIG. 6 is a diagram showing a further modified example of the configuration of the head section 12.

FIG. 7 is a diagram showing a further modified example of the configuration of the head section 12.

FIG. 8 is a diagram showing a further modified example of the configuration of the head section 12.

FIG. 9 is a diagram explaining an amount to displace positions of the inkjet heads 204 in a sub scanning direction.

FIG. 10 relates to a further modified example of the configuration of the head section 12, and is a diagram showing an example of a configuration of color ink discharging sections 202y to 202k.

### DETAILED DESCRIPTION OF EMBODIMENTS

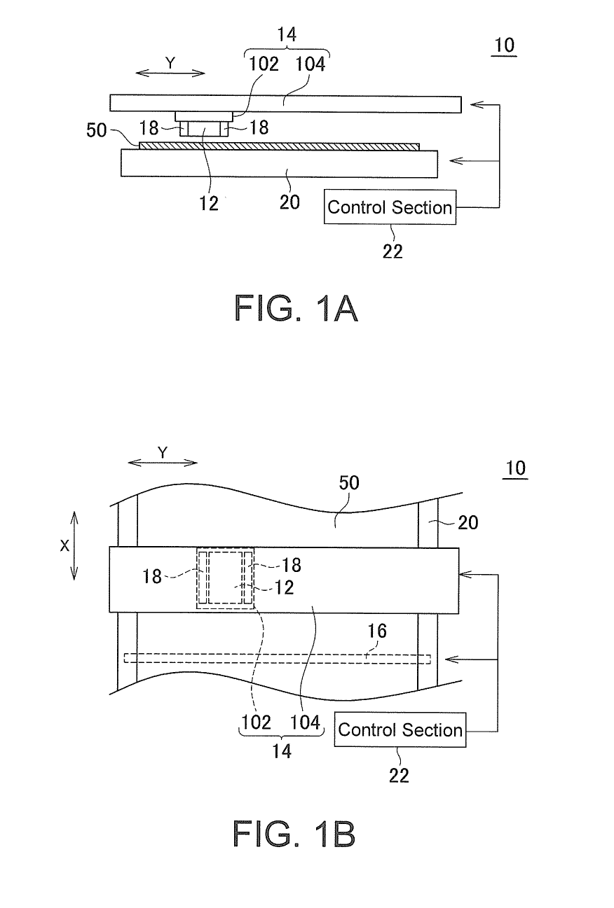

Hereinbelow, embodiments according to the present disclosure will be described with reference to the drawings. FIGS. 1A and 1B show examples of a printing device 10 according to an embodiment of the present disclosure. FIGS. 1A and 1B are a front diagram and an upper diagram showing an example of a configuration of a primary part of the printing device 10. Notably, other than the matter described hereinbelow, the printing device 10 may have an identical or similar configuration as a publicly known inkjet printer.

The printing device 10 is an inkjet printer that performs printing by an inkjet scheme on a medium (media) 50 that is a target of the printing. Further, in the present example, the printing device 10 is for example an inkjet printer that performs printing by a serial scheme that causes inkjet heads to perform main scanning operations (scan operations), and includes a head section 12, a main scan driving section 14, a sub scan driving section 16, ultraviolet light sources 18, a platen 20, and a control section 22.

The head section 12 is a part that performs printing on the medium 50, and forms ink dots corresponding to each pixel in an image to be printed on the medium 50 according to instructions of the control section 22. Further, in the present example, the head section 12 includes a plurality of inkjet heads that respectively discharges ink droplets of ultraviolet curing ink (UV ink) that cures by ultraviolet irradiation. Further, each of the plurality of inkjet heads includes a nozzle row. In this case, the nozzle row refers for example to a row in which a plurality of nozzles aligns at a constant interval in a certain direction. Further, the nozzles refer for example to holes that discharge the ink droplets. More specific configurations and operations of the head section 12 will be described later in further detail.

The main scan driving section 14 is a driving section that causes the head section 12 to perform the main scanning operations. In this case, the main scanning operations refer for example to operations of discharging the ink droplets onto the medium 50 while moving in a preset main scanning direction (Y direction in the drawings). Further, causing the head section 12 to perform the main scanning operations refers for example to causing the inkjet heads in the head section 12 to perform the main scanning operations. In the present example, the main scan driving section 14 includes a carriage 102 and a guide rail 104. The carriage 102 retains the head section 12 in a state where the nozzle rows of the inkjet heads and the medium 50 are opposed to each other. The guide rail 104 is a rail for guiding the movement of the carriage 102 in the main scanning direction, and allows the carriage 102 to move in the main scanning direction according to instructions from the control section 22.

The sub scan driving section 16 is a driving section that causes the head section 12 to perform sub scanning operations of moving relative to the medium 50 in a sub scanning direction, which is perpendicular to the main scanning direction. In this case, causing the head section 12 to perform the sub scanning operations refers for example to causing the inkjet heads in the head section 12 to perform the sub scanning operations. Further, in the present example, the sub scan driving section 16 is a roller that transfers the medium 50, and causes the head section 12 to perform the sub scanning operations by transferring the medium 50 in between main scanning operations.

Notably, as the configuration of the printing device 10, for example, a configuration in which the transfer of the medium 50 is not performed and instead the sub scanning operations are performed by moving the head section 12 side relative to the medium 50 with a fixed position (for example, X-Y table type device) may be considered to be used. In this case, as the sub scan driving section 16, for example, a driving section that moves the head section 12 by moving the guide rail 104 in the sub scanning direction may be used. Alternatively, one of the medium 50 or the platen 20 may be considered to be moved.

An ultraviolet light source 18 is a light source that irradiates ultraviolet ray on the ink dots formed on the medium 50. As the ultraviolet light source 18, for example, a UV LED or the like may suitably be used. Further, in the present example, the printing device 10 includes a plurality of ultraviolet light sources 18. Each of the plurality of ultraviolet light sources 18 is arranged on one side and the other side of the head section 12 in the main scanning direction so as to intervene the head section 12 therebetween in the main scanning direction.

The platen 20 is a stage-shaped member for mounting the medium 50, and supports the medium 50 by facing a nozzle surface where the nozzles are formed in the inkjet heads of the head section 12. The control section 22 is for example a CPU of the printing device 10, and controls operations of respective parts of the printing device 10 for example according to instructions from a host PC. Further, more specifically, in the present example, the control section 22 causes the printing device 10 to perform a multi-pass scheme printing by controlling the operations of the respective parts. In this case, the multi-pass scheme is for example a scheme by which plural times of the main scanning operations are performed on each position in a printed region, where the printing is to be performed in the medium 50. Further, in this case, the main scan driving section 14 and the sub scan driving section 16 cause the head section 12 to perform the multi-pass scheme printing by causing the head section 12 to perform the main scanning operations and the sub scanning operations at preset timings. According to these configurations, the printing device 10 performs printing on the medium 50.

Notably, as described above, with the head section 12 in the present example, the ultraviolet curing ink is used. However, in a modified example of the head section 12, ink other than the ultraviolet curing ink may be considered to be used. For example, as the ink, solvent UV ink, solvent ink, latex ink, or water-soluble dye ink, or the like may be considered to be used. In these cases, the printing device 10 preferably includes a heater or the like for heating the medium, for example. In this case, the heater is arranged for example in the platen 20 at a position facing the head section 12, and removes solvent (organic solvent or the like) included in the ink on the medium 50 in a volatile manner, by heating the medium 50.

Next, more specific configuration of the head section 12 will be described in detail. Firstly, for the sake of easiness of explanation, a head section with a configuration different from the head section 12 used in the present example (hereinbelow referred to as the head section of the referential example) will be described.

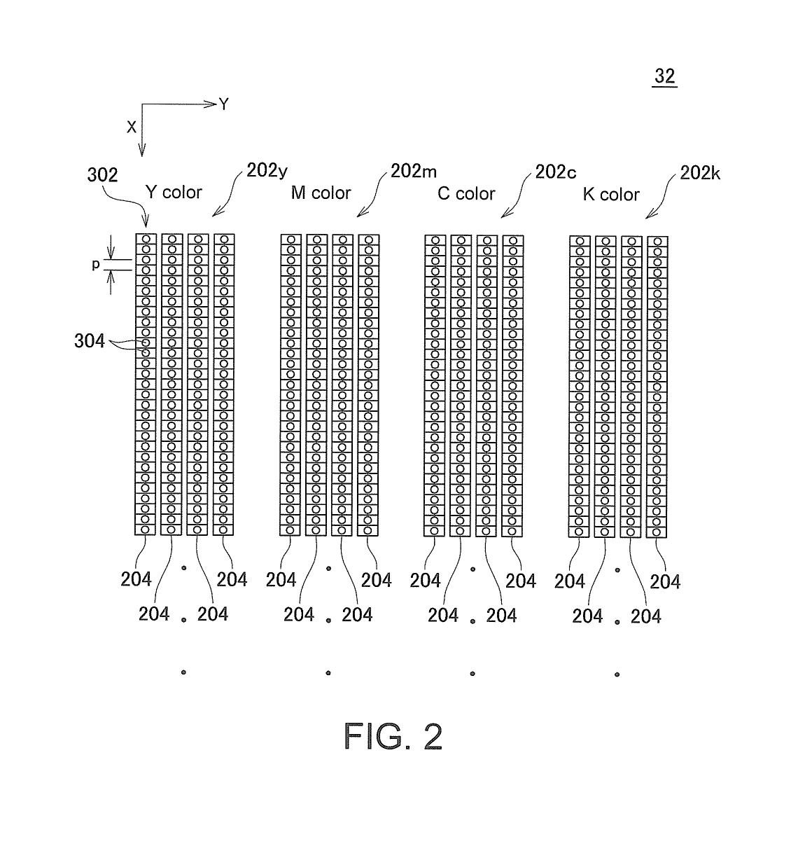

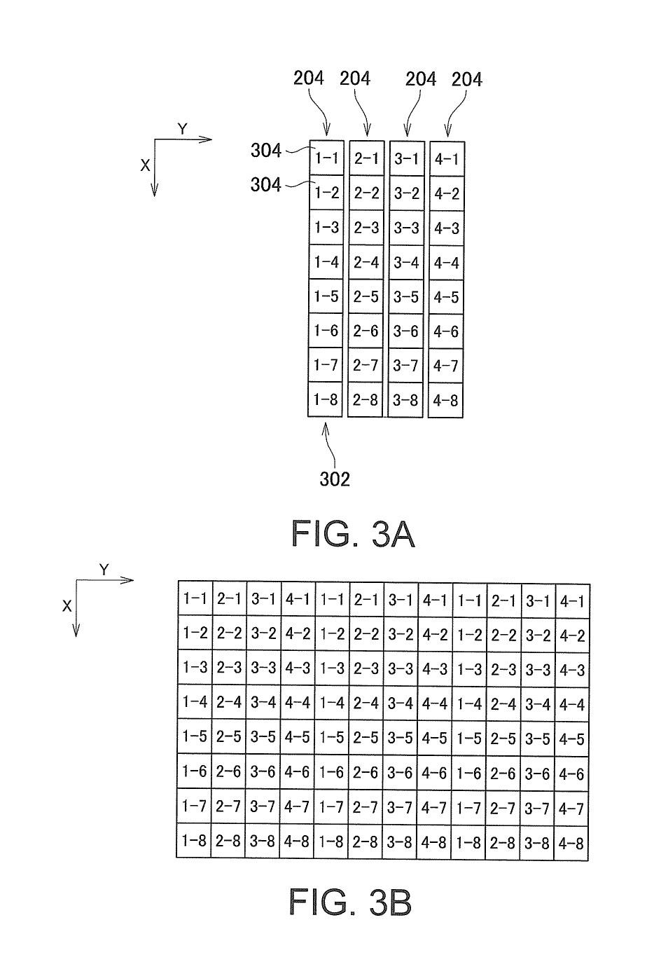

FIGS. 2, 3A, and 3B are diagrams explaining the head section of the referential example. FIG. 2 shows an example of a referential configuration example 32, which is an example of the head section of the referential example.

In the case shown in FIG. 2, the referential configuration example 32 includes a plurality of color ink discharging sections 202y, 202m, 202c, 202k (hereinbelow referred to as color ink discharging sections 202y to 202k). Each of the color ink discharging sections 202y to 202k are parts where ink droplets of colors different from each other are discharged, and discharges ink droplets of a corresponding color in process colors of printing. Further, more specifically, in the referential configuration example 32, each of the color ink discharging sections 202y to 202k discharges the ink droplets of the corresponding color among Y (yellow), M (magenta), C (cyan), and K (black).

Further, in the referential configuration example 32, each of the color ink discharging sections 202y to 202k includes a plurality of inkjet heads 204. Further, in each of the color ink discharging sections 202y to 202k, the plurality of inkjet heads 204 is arranged along the main scanning direction, with matched positions in the sub scanning direction.

Further, more specifically, in the case shown in the drawings, the color ink discharging section 202y includes four inkjet heads 204 that discharge the ink droplets of Y color. Further, each of the inkjet heads 204 in the color ink discharging section 202y includes a nozzle row 302 in which a plurality of nozzles 304 is aligned along the sub scanning direction at a certain interval (pitch) p. Further, each of the color ink discharging sections 202m, 202c, 202k has same configuration as that of the color ink discharging section 202y.

Further, in the referential configuration example 32, the interval p of the nozzles 304 in each inkjet head 204 is set to match a distance corresponding to a print resolution in the sub scanning direction. For example, in a case where the print resolution in the sub scanning direction is 600 dpi, the plurality of nozzles 304 in the nozzle row 302 of each inkjet head 204 is aligned with the interval p in the sub scanning direction of 1/600 inch.

Here, conventionally, in the inkjet printer for example, the multi-pass scheme printing has been often performed for purposes of increasing the print resolution in the sub scanning direction or suppressing the variation in the discharge properties of respective nozzles or the like. With respect to this, in the case of the referential configuration example 32, since the plurality of nozzles 304 is aligned in the sub scanning direction at the interval p corresponding to the print resolution, the print resolution in the sub scanning direction does not need to be increased by the multi-pass scheme.

Further, in the referential configuration example 32, the plurality of inkjet heads 204 that is arranged along the main scanning direction is used for each of the ink color (for each ink color of YMCK) is used. Thus, for the purpose of suppressing the variation in the discharge properties of respective nozzles as well, the discharge properties of the nozzles can be suitably averaged by discharging the ink droplets by the plurality of inkjet heads 204 in one main scanning operation onto each region that is to be the print target, without performing the multi-pass scheme printing. Further, due to this, the multi-pass scheme can be enabled in a so-called pseudo manner, without actually performing the multi-pass scheme printing. Thus, in the case of using the referential configuration example 32, high quality and high resolution printing can be performed by performing only one main scanning operation onto each region on the medium without performing the multi-pass scheme printing.

FIGS. 3A and 3B show an example of the printing operation using the referential configuration example 32. FIG. 3A is a diagram explaining the arrangement of the nozzles 304 in the inkjet heads 204, and indicates the plurality of ink discharging sections 202y to 202k by sequentially numbering the nozzles 304 in the nozzle rows 302.

Notably, in FIG. 3A, for the easiness of depiction, the number of the nozzles 304 in each inkjet head 204 is shown to be only eight. In an actual configuration, the inkjet heads 204 may have larger numbers of nozzles 304.

In the configuration shown in FIGS. 2, 3A, and 3B, each of the color ink discharging sections 202y to 202k includes four inkjet heads 204. Further, in FIG. 3A, the plurality of nozzles 304 in the inkjet head 204 on the farthest left side in the drawing is shown with numbers 1-1, 1-2, . . . 1-8, orderly from an upper side of the drawing. Further, the plurality of nozzles 304 in the inkjet head 204 of the second row from the left is shown with numbers 2-1, 2-2, . . . 2-8, orderly from the upper side of the drawing. The plurality of nozzles 304 in the inkjet head 204 of the third row from the left is shown with numbers 3-1, 3-2, . . . 3-8, orderly from the upper side of the drawing. The plurality of nozzles 304 in the inkjet head 204 of the fourth row from the left is shown with numbers 4-1, 4-2, . . . 4-8, orderly from the upper side of the drawing.

FIG. 3B is a diagram explaining the operation to perform printing on the medium 50 using the referential configuration example 32, and indicates an example of the arrangement of the pixels formed by the nozzles 304 as numbered in FIG. 3A. In the case of performing priming using the referential configuration example 32, the plurality of inkjet heads 204 in each of the color ink discharging sections 202y to 202k in the main scanning operation move in the main scanning direction (Y direction), and discharges the ink droplets onto positions of the respective pixels as set in advance. Further, in this case, more specifically, for example, the ink droplets are discharged to the positions of the pixels shown in the drawing by the nozzles 304 given the numbers in each of the inkjet heads 204.

In configuring as above, by using the nozzle rows 302 in which the plurality of nozzles 304 aligns at the interval p corresponding to the print resolution in the sub scanning direction, the print resolution in the sub scanning direction can be increased appropriately without performing the multi-pass scheme printing. More specifically, the print resolution in the sub scanning direction may be considered for example to be set at a resolution of 600 dpi or more.

Further, in configuring as above, as shown in the drawing for example, the ink dots aligned in the main scanning direction is formed orderly by each of the four rows of nozzle rows 302 included in the four inkjet heads 204. Thus, by configuring as this, for example, the discharge properties of the nozzles can be suitably averaged without performing the multi-pass scheme printing. Further, due to this, the configuration is enabled that performs the so-called pseudo manner, and high quality printing becomes possible. Further, in this case, by using the plurality of nozzle rows 302, for example, the print resolution in the main scanning direction can be increased appropriately without slowing down the printing speed. More specifically, the print resolution in the main scanning direction may be considered for example to be set at a resolution of 600 dpi or more.

Thus, in the case of using the referential configuration example 32, high quality and high resolution printing can be performed by performing only one main scanning operation onto each region on the medium without performing the multi-pass scheme printing. Further, in this case, the printing speed can be sped up because the number of necessary main scanning operations is reduced. More specifically, for example, when a comparison is made with a case of one inkjet head 204 for each color as with the printing operation often performed by the conventional inkjet printer, the printing speed can be sped up by a ratio of the pass numbers of the printing to perform the high quality printing of about the same degree. For example, when a comparison is made with a case of setting the pass number of printing in the conventional configuration to 16 times (16 passes), the high quality and high resolution printing of about the same degree is performed and the printing speed can be sped up to about 16 times faster.

However, as described above, in the case of the referential configuration example 32, in the nozzle row 302 of each of the inkjet heads 204, the plurality of nozzles 304 is aligned at the interval corresponding to the print resolution. Further, in the recent years, as the print resolution, for example a high resolution of 600 dpi or more is required. Further, in this case, the interval of the nozzles 304 comes to be of an extremely small interval of 1/600 inch or less.

Thus, in the case of using the configuration such as the one in the referential configuration example 32, the quality required for the inkjet heads 204 becomes extremely high, and there is a risk that the price of the inkjet head 204 increases dramatically. Further, for example, in a case of a piezoelectric inkjet head 204 that uses the piezoelectric element as its driving element, it is difficult in its nature to arrange nozzles at the interval corresponding to such high resolution of 600 dpi or more.

Thus, the inventors of the present application have, as a result of further study, eagerly considered of performing printing using a plurality of nozzle rows having nozzles arranged at the interval corresponding to a lower resolution than the print resolution. Hereinbelow, the configuration and operation of the head section 12 of the present example will be described in further detail.

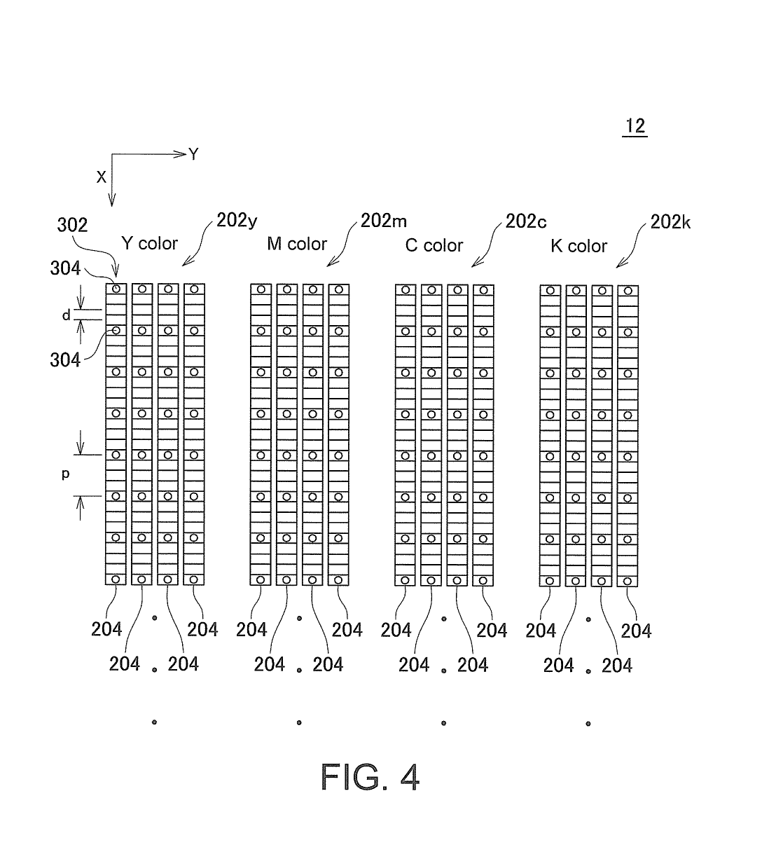

FIG. 4 shows an example of the configuration of the head section 12 in the present example. Notably, hereinbelow, other than the parts described below, configurations in FIG. 4 given the same reference signs as FIG. 2 have identical or similar features as the configuration of FIG. 2.

In the present example, similar to the referential configuration example 32 described by using FIG. 2 or the like, the head section 12 includes the color ink discharging sections 202y to 202k. Due to this, the printing device 10 (see FIGS. 1A and 1B) performs printing by using the ink of the respective colors of YMCK, which are plural types of ink with different colors. Further, each of the color ink discharging sections 202y to 202k includes a plurality of inkjet heads 204. Each of the inkjet heads 204 includes nozzle rows 302 along which a plurality of nozzles 304 is aligned. Due to this, the head section 12 includes the plurality of nozzle rows 302 for each of the colors of YMCK, similar to the referential configuration example 32. Further, for each of the nozzle rows 302, the plurality of nozzle rows 302 is aligned with a constant interval in the sub scanning direction.

On the other hand, in the present example, the interval p of the nozzles 304 in the nozzle row 302 of each inkjet head 204 differs from the case of the referential configuration example 32. Thus, hereinbelow, this point will be described in detail.

In the present example, the plurality of nozzles 304 in each nozzle row 302 is aligned with their interval in the sub scanning direction being the constant interval p. In this case, in denoting the resolution corresponding to the interval p as a nozzle resolution D1, each inkjet head 204 forms ink dots at a density by which resolution in the sub scanning direction becomes the nozzle resolution D1.

Further, in the present example, the printing device 10 performs higher-resolution printing than the nozzle resolution D1 by performing the multi-pass scheme printing. More specifically, for example, in denoting a resolution in the sub scanning direction in a case of performing printing at the highest resolution in the printing device 10 using the multi-pass scheme as a maximum resolution D2, the maximum resolution D2 is set to be a resolution higher than the nozzle resolution D1.

Further, in the case shown in FIG. 4, the maximum resolution D2 is a distance corresponding to a distance d shown in the drawing. Further, this distance d is a distance between dots in the sub scanning direction in the ink dot alignment formed by the multi-pass scheme. Further, in this case, the maximum resolution D2 being higher than the nozzle resolution D1 means for example that the distance d is smaller than the interval p of the nozzles 304.

More specifically, for example, in a case where each of the color ink discharging sections 202y to 202k includes four inkjet heads 204, and printing is performed by multi-pass scheme by the pass number being four times, the distance d becomes ¼ of the interval p. Further, in this case, more specifically, for example, in a case where the nozzle resolution D1 is 150 dpi and the interval p of the nozzles 304 is 1/150 inch, the maximum resolution D2 becomes 600 dpi, and the distance d becomes 1/600 inch.

In configuring as above, by using the plurality of nozzle rows 302 for each color of ink in each of the color ink discharging sections 202y to 202k, for example, the discharge properties of the nozzles can suitably be averaged similar to the case where the explanation was given using FIGS. 2, 3A, and 3B. Further, for example, as compared to the conventional configuration, the number of necessary main scanning operations can be reduced, and the printing speed can be sped up. More specifically, in this case, for example, the high quality and high resolution printing of about the same degree as the case where the pass number of printing is set to 16 times in the conventional configuration can be realized by 4-pass printing. Further, due to this, the printing speed can be sped up (for example, about 4 times faster).

Further, in this case, unlike from the referential configuration example 32, the cost or the like for the inkjet head 204 can be suitably suppressed for example, due to the nozzle resolution D1 being lower than the maximum resolution D2. More specifically, for example, as each of the inkjet heads 204, inkjet heads that are identical to or similar to the inkjet head that is publicly known and general may be used. Further, as the driving element for causing the ink droplets to discharge, it is possible to use inkjet heads 204 using the piezoelectric element. Thus, according to the present example, for example, the high quality printing at high resolution can be performed at high speed using plural types of ink while suppressing the cost. Further, due to this, for example, a high quality color image can suitably be printed.

Here, in the present example, the operation of the multi-pass scheme can suitably be performed for example by suitably setting a transfer amount of the head section 12 (feed amount) in the sub scanning direction according to the print resolution. In this case, each of the inkjet heads 204 in each of the color ink discharging sections 202y to 202k discharges the ink droplets based on preset mask data. Further, the mask data is for example data designating pixels for which the ink droplets are to be discharged in each of the main scanning operations in the multi-pass scheme.

Further, the print resolution D2 may be a resolution higher than 600 dpi. In this case, for example, consideration may be given to making the print pass number further increased to perform higher-resolution printing. Further, in a case of a more generalized indication, the maximum resolution D2 may be a resolution that is N times the nozzle resolution D1 (N being an integer of 2 or more). In this case, the printing device 10 performs is printing in the maximum resolution D2 by performing priming in the multi-pass scheme for example of which print pass number is N or more.

Further, in FIG. 4, as to the configuration of the color ink discharging sections 202y to 202k, an example of the configuration of a case where the positions in the sub scanning direction are matched for all of the inkjet heads 204 and the nozzles 304 is shown. More specifically, in the case of the configuration shown in FIG. 4, the plurality of nozzle rows 302 that each discharges the ink droplets of the same color of ink in each of the color ink discharging sections 202y to 202k is arranged along the main scanning direction with the positions of the nozzles 304 therein in the sub scanning direction matched with each other. By configuring as this, for example, the plurality of nozzle rows 302 can suitably be used for each color. Further, in the configuration shown in FIG. 4, the positions in the sub scanning direction are matched for the inkjet heads 204 and the nozzle rows 302 discharging the ink droplets of different colors by matching the positions of the color ink discharging sections 202y to 202k in the sub scanning direction.

However, in a modified example of the configuration of the head section 12, the positions of the inkjet heads 204 and the nozzles 304 in the sub scanning direction may be considered to be displaced upon arranging them. Thus, hereinbelow, various modified examples of the configuration of the head section 12 will be described.

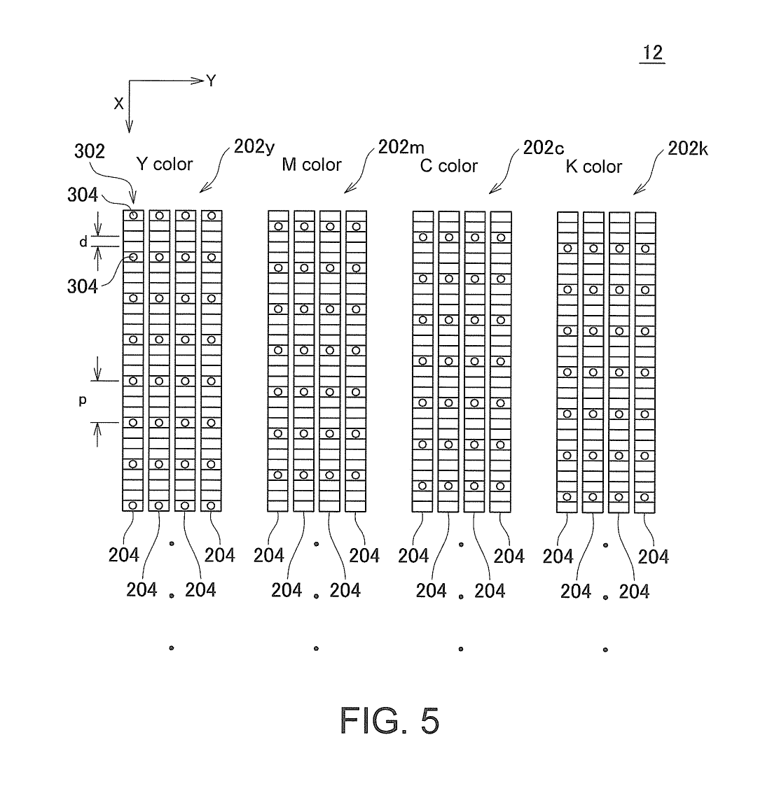

FIG. 5 is a diagram showing a modified example of the configuration of the head section 12. Notably, hereinbelow, other than the parts described below, configurations in FIG. 5 given the same reference signs as FIG. 4 have identical or similar features as the configuration of FIG. 4.

In this modified example, the plurality of inkjet heads 204 provided in each of the color ink discharging sections 202y to 202k has their positions matched in the sub scanning direction, and is arranged along the main scanning direction. Thus, the configuration of each of the color ink discharging sections 202y to 202k may be identical to or similar to the case shown in FIG. 4.

On the other hand, the arrangement of the color ink discharging sections 202y to 202k is configured so as to have their positions displaced in the sub scanning direction among the colors (inter-color displacement). This configuration is a configuration that for example as shown in the drawing sets the positions of the inkjet heads 204 discharging the ink droplets of different colors are displaced.

More specifically, in this case, for example, for each of the inkjet heads 204 of the color ink discharging section 202y, a position in the sub scanning direction at an end of each nozzle row 302 is arranged to match a predetermined position. Further, for each of the inkjet heads 204 of the color ink discharging section 202m, a position in the sub scanning direction of an end of each nozzle row 302 is arranged so as to be displaced from the positions of the ends of the nozzle rows 302 of the color ink discharging section 202y. Further, for each of the inkjet heads 204 of the color ink discharging section 202c, a position in the sub scanning direction of an end of each nozzle row 302 is arranged so as to be displaced from the positions of the ends of the nozzle rows 302 of the color ink discharging section 202y and the color ink discharging section 202m. Further, for each of the inkjet heads 204 of the color ink discharging section 202k, a position in the sub scanning direction of an end of each nozzle row 302 is arranged so as to be displaced from the positions of the ends of the nozzle rows 302 of the color ink discharging section 202y, the color ink discharging section 202m, and the color ink discharging section 202c. Due to this, among the respective colors of ink of YMCK, the nozzle rows 302 discharging the ink droplets of one color of ink and the nozzle rows 302 discharging the ink droplets of another color of ink are arranged with their positions of the nozzles therein in the sub scanning direction displaced from each other.

In configuring as above, by using the plurality of nozzle rows 302 for each color of ink in each of the color ink discharging sections 202y to 202k, for example, the discharge properties of the nozzles can suitably be averaged similar to the case where the explanation was given using FIG. 4. Further, in configuring as this, by making some of the control different according to how the positions of the plurality of color ink discharging sections 202y to 202k are displaced, similar to the case described using FIG. 4. Further, due to this, for example, as compared to the conventional configuration, the number of necessary main scanning operations can be reduced, and the printing speed can be sped up. More specifically, in this case, for example, the high quality and high resolution printing of about the same degree as the case where the pass number of printing is set to 16 times in the conventional configuration can be realized by 4-pass printing. Further, due to this, the printing speed can be sped up (for example, about 4 times faster).

Further, in this case, for example, as the inkjet heads 204, inkjet heads (for example, a piezoelectric inkjet head or the like of a piezoelectric scheme) that are identical to or similar to the inkjet head that is publicly known and general may be used. Thus, according to the present modified example, for example, the high quality printing at high resolution can be performed at high speed using plural types of ink while suppressing the cost.

Further, in the case of the present modified example, further in each of the main scanning operations, the ink dots of the respective colors are formed with their positions in the sub scanning direction displaced from each other. In this case, for example, the dots of the ink of different colors are suitably prevented from being formed adjacent in the main scanning direction. Further, due to this, for example, inter-color smearing or the like is suitably prevented from occurring between the dots of the ink of different colors. Thus, according to the modified example, for example, the high quality printing at high resolution can more suitably be performed.

Notably, in the case shown in FIG. 5, a distance by which the positions of the nozzle rows 302 are displaced among the colors is made equal to the distance d corresponding to the maximum resolution D2. Further, as to the distance for displacing the positions of the nozzle rows 302 among the colors, in a case of a more generalized indication, for example, consideration may be given to denoting the interval of the nozzles 304 in each nozzle row 302 as p, denoting the number of the inkjet heads 204 in each of the color ink discharging sections 202y to 202k as k, and setting the distance to an integral multiple of p/k and that is not an integral multiple of p. By configuring as this, for example, the positions of the nozzle rows 302 among the colors can suitably be displaced.

Further, in the above, the description is given for a case where the positions of the nozzle rows 302 in the sub scanning direction are displaced positionally among the colors. However, in a further modified example of the configuration of the head section 12, the positions of the nozzle rows 302 for the ink droplets of the same color may be displaced in each of the color ink discharging sections 202y to 202k.

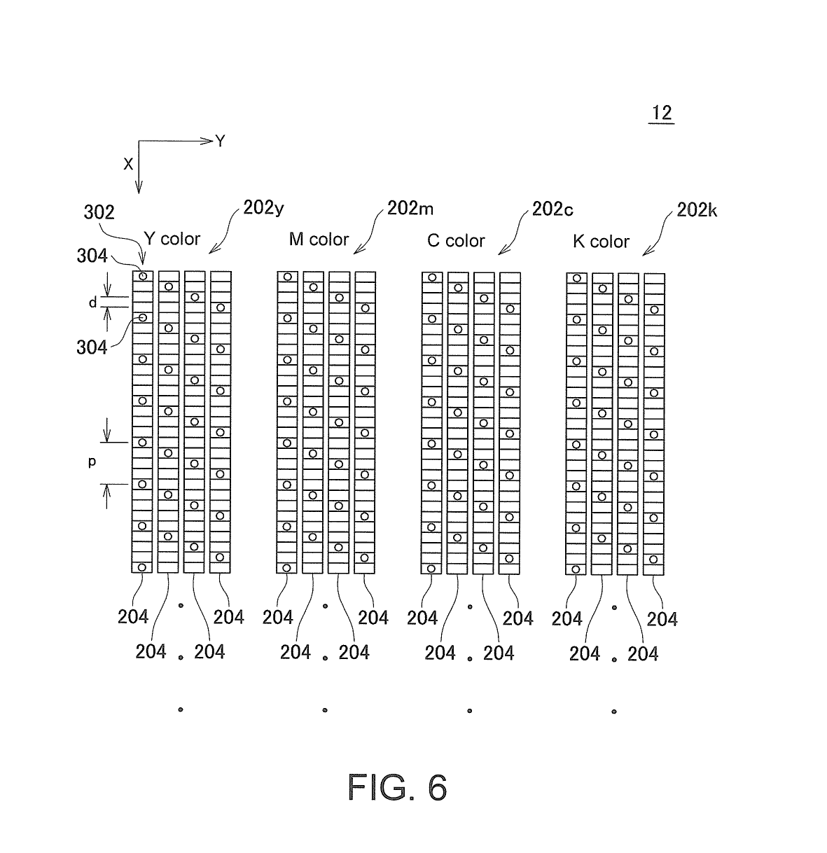

FIG. 6 is a diagram showing a modified example of the configuration of the head section 12. Notably, hereinbelow, other than the parts described below, configurations in FIG. 6 given the same reference signs as FIG. 4 or 5 have identical or similar features as the configuration of FIG. 4 or 5.

In the case of the present modified example, in each of the color ink discharging sections 202y to 202k, the plurality of inkjet heads 204 is arranged along the main scanning direction with their positions in the sub scanning direction displaced from each other. Further, due to this, each of the plurality of nozzle rows 302 that discharges the ink droplets of the same color is arranged along the main scanning direction so that some of their positions in the sub scanning direction overlap.

Further, in the present modified example, the color ink discharging sections 202y to 202k for example have same or similar configuration other than the color of the ink to be used. Further, they are arranged along the main scanning direction with their positions in the sub scanning direction matched as shown in the drawing.

In configuring as above, the multi-pass scheme printing can suitably be performed similar to the case described using FIG. 4 or 5 by making some of the control different according to how the positions of the plurality of inkjet heads 204 are displaced in the color ink discharging sections 202y to 202k. Further, due to this, the discharge properties of the nozzles can be suitably averaged. Further, for example, as compared to the conventional configuration, the number of necessary main scanning operations can be reduced, and the printing speed can be sped up. More specifically, in this case, for example, the high quality and high resolution printing of about the same degree as the case where the pass number of printing is set to 16 times in the conventional configuration can be realized by 4-pass printing. Further, due to this, the printing speed can be sped up (for example, about 4 times faster).

Further, in this case, for example, as the inkjet heads 204, inkjet heads that are identical to or similar to the inkjet head that is publicly known and general may be used. Thus, according to the present modified example, for example, the high quality printing at high resolution can be performed at high speed using plural types of ink while suppressing the cost.

In addition, in the case of present modified example, in each of the main scanning operations, each of the plurality of nozzle rows 302 for each color has its position in the sub scanning direction displaced from each other for example, and thereby forms the ink dots. Then, in this case, the printing by the plurality of nozzle rows 302 can be performed without forming the ink dots consecutively at positions that are adjacent in the main scanning direction for the dots of ink of the same color. Thus, according to the present modified example, for example, the dots of ink of the same color can more suitably be prevented from coupling in the main scanning direction. Further, due to this, for example, the generation of line bands (line bands or the like in the main scanning direction generated in the printing device using ultraviolet curing ink) is suppressed, and even higher quality printing can suitably be performed.

Here, in the case shown in FIG. 6, a distance by which the positions of the nozzle rows 302 are displaced among the color ink discharging sections 202y to 202k is equal to the distance d corresponding to the maximum resolution D2. Further, as to the distance for displacing the positions of the nozzle rows 302 among the color ink discharging sections 202y to 202k, in a case of a more generalized indication, for example, consideration may be given to denoting the interval of the nozzles 304 in each nozzle row 302 as p, denoting the number of the inkjet heads 204 in each of the color ink discharging sections 202y to 202k as k, and setting the distance to an integral multiple of p/k and that is not an integral multiple of p. By configuring as this, for example, the positions of the nozzle rows 302 among the color ink discharging sections 202y to 202k can suitably be displaced.

Further, in the above, the explanation is given of the case where the number of the inkjet heads 204 provided in each of the color ink discharging sections 202y to 202k is mainly four. However, the number of the inkjet heads 204 provided in each of the color ink discharging sections 202y to 202k may be other than four. In this case, in order to perform the high quality printing at high speed by the number of the inkjet heads 204 provided in each of the color ink discharging sections 202y to 202k, for example, it is preferable to set it to four or more. Further, depending on the necessary print quality or required printing speed, for example, the number of the inkjet heads 204 may be 3 or less.

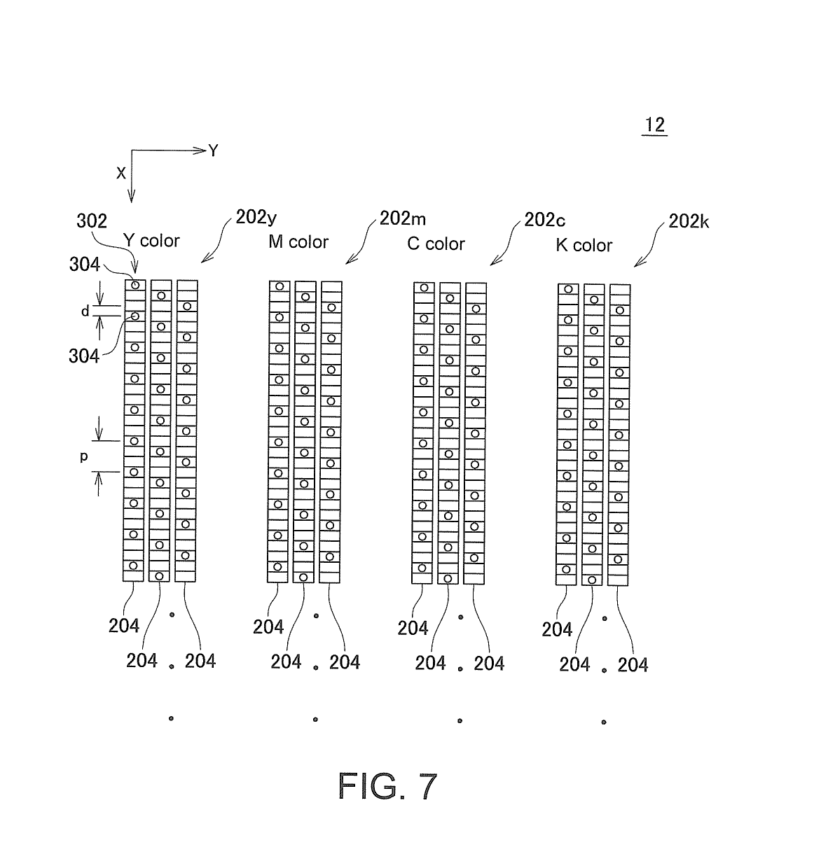

FIG. 7 is a diagram showing a further modified example of the configuration of the head section 12. Notably, hereinbelow, other than the parts described below, configurations in FIG. 7 given the same reference signs as FIGS. 4 to 6 have identical or similar features as the configurations of FIGS. 4 to 6.

In this modified example, each of the color ink discharging sections 202y to 202k includes three inkjet heads 204. Further, in each of the color ink discharging sections 202y to 202k, the three inkjet heads 204 are arranged along the main scanning direction with their positions in the sub scanning direction displaced.

In configuring as above, the multi-pass scheme printing can suitably be performed similar to the case described using FIG. 6 by making some of the control different according to the difference in the numbers of the plurality of inkjet heads 204 in the color ink discharging sections 202y to 202k. Further, due to this, same or similar advantage as the case described using FIG. 6 for example can be achieved.

Notably, in the present modified example, due to the difference in the numbers of the inkjet heads 204 in the color ink discharging sections 202y to 202k, for example, the multi-pass scheme printing may be considered to be performed with the number of the print passes set to 3 times. Further, in this case, for example, the high quality and high resolution printing of about the same degree as the case where the pass number of printing is set to 9 times (9 pass) in the conventional configuration can be realized by 3-pass printing. Further, due to this, the printing speed can be sped up (for example, about 3 times faster).

Here, as to how the positions of each of the inkjet heads 204 in the color ink discharging sections 202y to 202k, in FIGS. 6 and 7, depiction and explanation were given of a case where the positions of the nozzles 304 at the end of the nozzle rows 302 are displaced one by one in the sub scanning direction by the distance d from one side to the other side of the main scanning direction (for example, from the right side to the left side in the drawing). However, how the positions of the inkjet heads 204 are displaced is not limited to the above method, and such may be configured differently in various ways. For example, the positions of the nozzles of different colors may relatively be displaced.

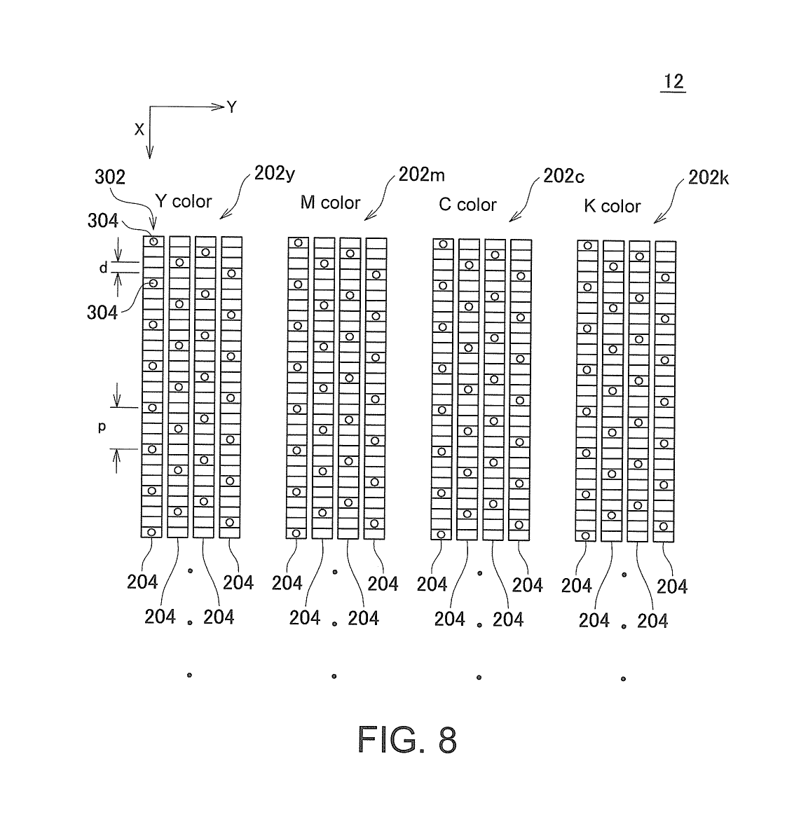

FIG. 8 is a diagram showing a further modified example of the configuration of the head section 12. Notably, hereinbelow, other than the parts described below, configurations in FIG. 8 given the same reference signs as FIGS. 4 to 7 have identical or similar features as the configurations of FIGS. 4 to 7.

In this modified example, each of the color ink discharging sections 202y to 202k has a configuration in which a part of an arrangement order of the inkjet heads 204 in the main scanning direction is made different relative to the color ink discharging sections 202y to 202k with the configuration explained using FIG. 6. More specifically, in the case shown in FIG. 8, each of the color ink discharging sections 202y to 202k has the configuration in which the inkjet head 204 of the second row from the right and the inkjet head 204 of the third row thereof are replaced relative to the configuration of FIG. 6.

In configuring as above, the multi-pass scheme printing can suitably be performed similar to the case described using FIG. 6 by making some of the control different according to the difference in the arrangements of the plurality of inkjet heads 204 in the color ink discharging sections 202y to 202k. Further, due to this, same or similar advantage as the case described using FIG. 6 for example can be achieved.

Further, as described above, in the present example, the head section 12 performs printing of images by performing the main scanning operations. With respect to this, in a case of observing an image printed by the main scanning operations, there is a case where alignment of the ink dots formed by nozzles 304 at the ends among the nozzle rows 302 used for printing is more noticeable. Further, as a result, there is a case where the line band or the like stands out, and is visually recognized.

With respect to this, in the case of the present modified example, in each of the color ink discharging sections 202y to 202k, the plurality of nozzle rows 302 is not aligned in a line, but is arranged so that the positions of their ends form a zigzag pattern. By configuring as this, for example, the influence of the nozzles 304 at the ends among the nozzles 304 can be dispersed in the sub scanning direction. Due to this, according to the present modified example, for example, the generation of the line bands formed by influence of the ink dots formed by the nozzles 304 at the ends of the nozzle rows 302 is suitably prevented. Further, due to this, for example, the highly accurate printing can be performed more appropriately.

Further, in a case of considering such an effect, in a further modified example of the configuration of the head section 12, for example, consideration may be given to making the amount to displace the positions of the inkjet heads 204 in each of the color ink discharging sections 202y to 202k to even a larger distance, instead of the distance d corresponding to the maximum resolution D2 or the distances that are several times this distance, for example. Thus, hereinbelow, this point will be described in detail.

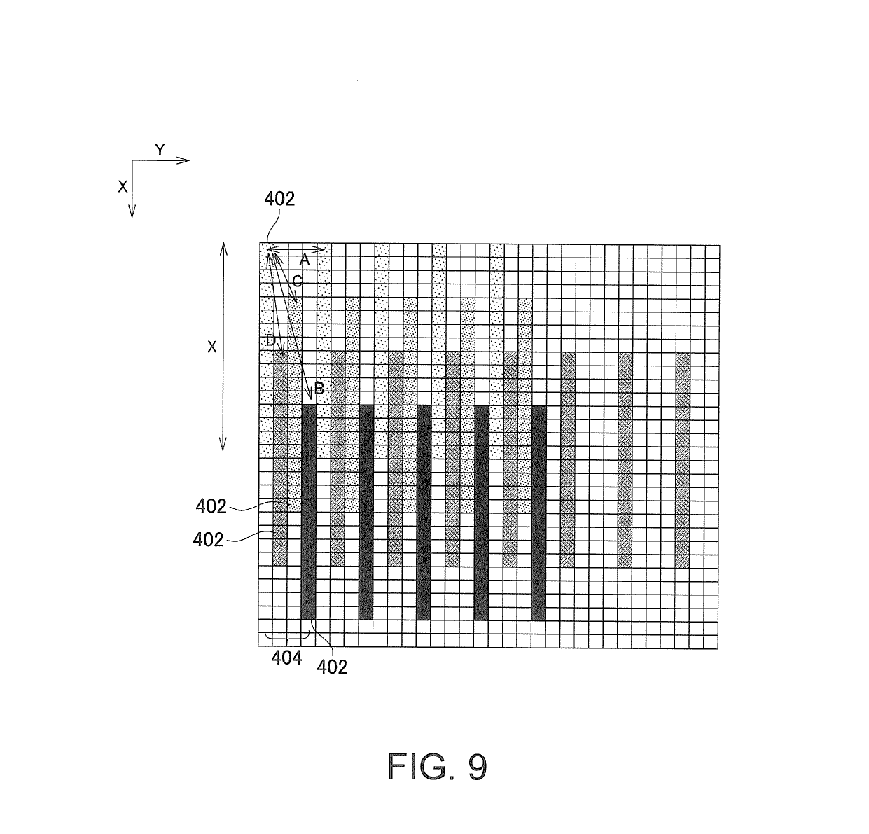

FIG. 9 is a diagram explaining the amount for displacing the inkjet heads 204 in the sub scanning direction, relates to a case where the amount for displacing the positions of the inkjet heads 204 in each of the color ink discharging sections 202y to 202k is made larger, and shows an example of the region where the ink droplets are to be discharged by one main scanning operation by focusing on the plurality of inkjet heads 204 included in one of the color ink discharging sections 202y to 202k. Further, in FIG. 9, a region 402 shows an example of the region where the ink droplets are discharged by one nozzle row 302 at each of the positions in the main scanning direction. Further, the region 404 shows an example of a region where the ink droplets are discharged by one cycle performed by the plurality of inkjet heads 204 included in one of the color ink discharging sections 202y to 202k, among repeated cycles of moving to the main scanning direction and performing the ink droplet discharge in the main scanning operation. Further, a distance X shown in the drawing is a width of the region 402 in the sub scanning direction. The distance X for example is determined according to a length of the nozzle rows 302 and numbers of the nozzles 304 in the inkjet heads 204.

As in the configurations explained above, in a case of using a plurality of nozzle rows 302 for one color, an influence of the nozzles 304 at the ends overlaps when the positions of the nozzles 304 at the ends of the respective nozzle rows 302 are close to each other, and line bands may become prominent. With respect to this, for example, a distance between dots of ink formed by the nozzles 304 at the ends among the nozzles 304 is made larger, then, the influence imposed on vision sensitivity by the ink dots formed by the nozzles 304 at the ends can be dispersed. Further, due to this, for example, the line band standing out prominently or the like can suitably be suppressed, and the high quality printing can suitably be performed.

Further, in this case, more specifically, for example, as to the distance between the dots formed by the nozzles 304 at the ends in the nozzle rows 302 such as the respective distances shown by arrows with reference signs A to D in the drawing, such may be considered to be made larger than a distance corresponding to a spatial frequency by which the human vision sensitivity is maximized. Further, in a simpler sense, the respective distances shown by the arrows may be considered to be set for example to 200 μm or more.

Further, in this case, as a specific configuration of the head section 12, for example, for each of the each of the color ink discharging sections 202y to 202k, the size of the positional displacement for the positions in the sub scanning direction of the nozzle rows 302 at the ends of the plurality of nozzles 304 arranged adjacent to one another in the main scanning direction may be set to be larger than a distance corresponding to a spatial frequency by which human vision sensitivity is maximized. Further, as to this size of the positional displacement, more specifically, it may be set for example to 200 μm or more.

By configuring as above, for example, in each of the color ink discharging sections 202y to 202k, the influence imposed on vision sensitivity by the ink dots formed by the nozzles 304 at the ends of the nozzle rows 302 can be dispersed. Further, due to this, for example, the line band standing out prominently or the like can suitably be suppressed, and the high quality printing can suitably be performed.

Here, in the above, as the configuration of the color ink discharging sections 202y to 202k, the configuration provided with the plurality of inkjet heads 204 has mainly been described. However, in a further modified example of the configuration of the head section 12, each of color ink discharging sections 202y to 202k including only one inkjet head 204 may be considered to be used.

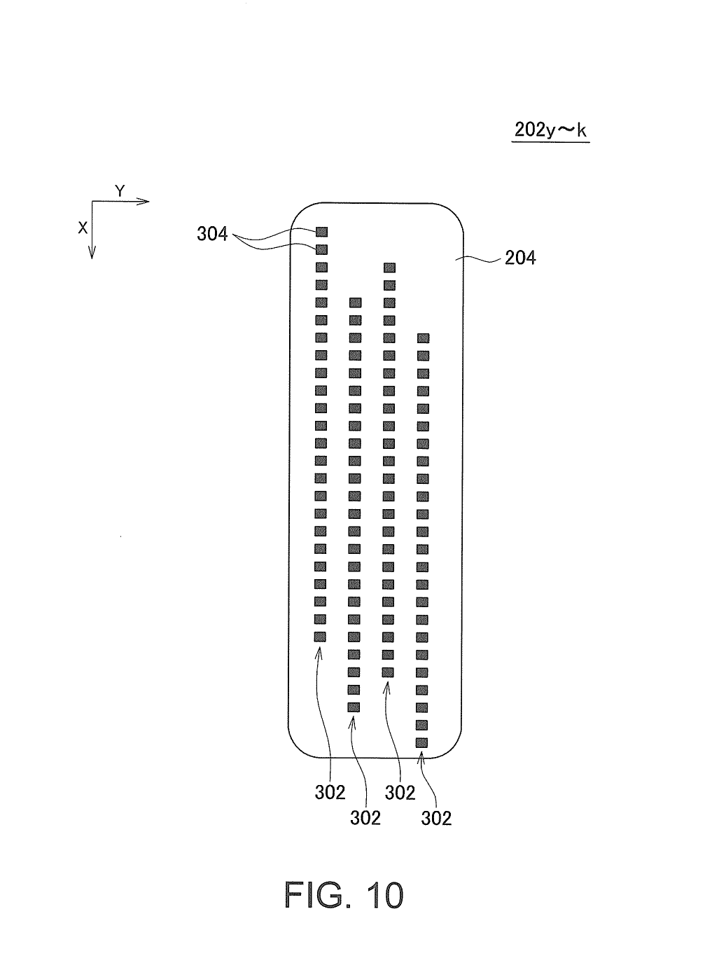

FIG. 10 relates to a further modified example of the configuration of the head section 12, and shows an example of a configuration of color ink discharging sections 202y to 202k. Notably, hereinbelow, other than the parts described below, configurations in FIG. 10 given the same reference signs as FIGS. 4 to 8 have identical or similar features as the configurations of FIGS. 4 to 8.

In this modified example, each of the color ink discharging sections 202y to 202k includes one inkjet head 204. Further, the inkjet head 204 includes a plurality of nozzle rows 302. In this case, each of the plurality of nozzle rows 302 is arranged along the main scanning direction so that at least a part of their positions in the sub scanning direction overlaps each other.

In this modified example, by using the plurality of nozzle rows 302, the operation of the nozzle rows 302 in the pseudo manner similar to the configurations described using FIGS. 4 to 8 can suitably be performed. Further, due to this, high quality printing with high resolution can be performed at high speed.

Further, more specifically, in the case shown in FIG. 10, the plurality of nozzle rows 302 is arranged along the main scanning direction with their positions of the nozzles 304 at the ends in the sub scanning direction displaced in the zigzag pattern. In this case, the plurality of nozzle rows 302 preferably is arranged so as to be able to use all of the nozzles 304 in all of the nozzle rows 302 at same time in each of the main scanning operations. Further, the number of the nozzle rows 302 is preferably four or more. Moreover, the positions of the nozzles 304 at the ends in each of nozzle rows 302 are preferably displaced larger than the distance corresponding to the spatial frequency by which human vision sensitivity is maximized, as described using FIG. 9. The size of the positional displacement of the nozzles 304 at the ends may be 200 μm or more. By configuring as above, for example, the influence imposed on vision sensitivity by the ink dots formed by the nozzles 304 at the ends of each of nozzle rows 302 can be dispersed. Further, due to this, for example, the line band standing out prominently or the like can suitably be suppressed, and the high quality printing can suitably be performed.

Further, in this case, for the independent configuration of the inkjet heads 204, it can be said as being a no-banding head in which banding is less likely to be generated. Thus, by configuring as above, for example, the no-banding head can be used to suitably perform the multi-pass scheme operation in the pseudo manner using the plurality of nozzle rows 302.

Further, as the configuration of the inkjet heads 204 having the plurality of nozzle rows 302, for example, the configuration corresponding to each of color ink discharging sections 202y to 202k in FIGS. 6 to 8 may be considered to be used. In this case, for example, in the inkjet heads 204, the plurality of nozzle rows 302 is aligned identical to or similar to the plurality of nozzle rows 302 in each of color ink discharging sections 202y to 202k of FIGS. 6 to 8. By configuring as above, for example, the configuration using the inkjet heads 204 provided with the plurality of nozzle rows 302 can achieve the advantage similar to FIGS. 6 to 8.

As above, the present disclosure has been described by using embodiments, however, the technical scope of the present disclosure is not limited to the scope described in the embodiments. It is apparent to those skilled in the art that various modifications and improvements can be made to the above embodiments. It is apparent from the description of the claims that embodiment including such modifications and improvements are within the technical scope of the present disclosure.

### INDUSTRIAL APPLICABILITY

The present disclosure may for example be suitably used in a printing device.

What is claimed is:

1. A printing device that performs printing on a medium using an inkjet scheme, the printing device comprising:
a head section including nozzle rows in which nozzles for discharging ink droplets are aligned;
a main scan driving section that causes the head section to perform a main scanning operation of discharging ink droplets while moving in a preset main scanning direction; and
a sub scan driving section that moves the head section in a sub scanning direction that is perpendicular to the main scanning direction relative to the medium,
wherein the head section includes a plurality of the nozzle rows that respectively discharges ink droplets of ink of a same color,
each of the plurality of nozzle rows is aligned along the main scanning direction so that at least a part of their positions is overlapped in the sub scanning direction,
in each of the nozzle rows, a plurality of the nozzles is aligned with a constant interval in the sub scanning direction, and
in a case where a resolution corresponding to the interval of the nozzles in the sub scanning direction in each of the nozzle rows is denoted as a nozzle resolution D1, and a resolution in the sub scanning direction upon performing printing at a maximum resolution in the printing device is denoted as a maximum resolution D2,
the maximum resolution D2 is a resolution higher than the nozzle resolution D1.

2. The printing device according to claim 1, wherein the main scan driving section and the sub scan driving section cause the head section to perform printing by a multi-pass scheme that performs plural times of the main scanning operations for each position in a printed region where printing is to be performed on the medium, and
the maximum resolution D2 is a maximum resolution obtained upon performing the printing in the multi-pass scheme.

3. The printing device according to claim 1, wherein the maximum resolution D2 is a resolution that is N times the nozzle resolution D1, where N is an integer greater than or equal to 2.

4. The printing device according to claim 1, wherein piezoelectric elements are used as driving elements for causing the ink droplets to be discharged in the head section.

5. The printing device according to claim 1, wherein the printing device performs printing using plural types of ink with colors different from each other, and the head section includes the plurality of nozzle rows for each of the colors.

6. The printing device according to claim 5, wherein the plurality of nozzle rows that discharges the ink droplets of the same color of ink is arranged along the main scanning direction with the respective nozzles having matched positions in the sub scanning direction.

7. The printing device according to claim 6, wherein, within the plural types of ink, the nozzle rows that discharge the ink droplets of one color and the nozzle rows that discharge the ink droplets of another color are arranged with the positions of the respective nozzles displaced in the sub scanning direction.

8. The printing device according to claim 5, wherein the plurality of nozzle rows that discharges the ink droplets of the same color of ink is arranged along the main scanning direction with the respective nozzles having positions in the sub scanning direction displaced from one another.

9. The printing device according to claim 8, wherein a size of a positional displacement for the positions in the sub scanning direction of the nozzles at ends of the plurality of nozzle rows arranged adjacent to one another in the main scanning direction is set to be larger than a distance corresponding to a spatial frequency by which human vision sensitivity is maximized.

10. The printing device according to claim 8, wherein a size of a positional displacement for the positions in the sub scanning direction of the nozzles at ends of the plurality of nozzle rows arranged adjacent to one another in the main scanning direction is 200 μm or more.

11. A printing method that performs printing on a medium using an inkjet scheme, the printing method comprising:
causing a head section that includes nozzle rows in which nozzles for discharging ink droplets are aligned to perform:
a main scanning operation of discharging ink droplets while moving in a preset main scanning direction; and
a sub scanning operation of moving in a sub scanning direction that is perpendicular to the main scanning direction relative to the medium,
wherein the head section includes a plurality of the nozzle rows that respectively discharges ink droplets of a same color,
each of the plurality of nozzle rows is aligned along the main scanning direction so that at least a part of their positions is overlapped in the sub scanning direction,
in each of the nozzle rows, a plurality of the nozzles is aligned with a constant interval in the sub scanning direction, and
in a case where a resolution corresponding to the interval of the nozzles in the sub scanning direction in each of the nozzle rows is denoted as a nozzle resolution D1, and a resolution in the sub scanning direction upon performing printing at a maximum resolution in the printing device is denoted as a maximum resolution D2,
the printing is performed with the maximum resolution D2 that is a resolution higher than the nozzle resolution D1.
